(19) United States
(12) Patent Application Publication
(10) Pub. No.: US 2022/0029374 A1
(43) Pub. Date: Jan. 27, 2022

(54) METHOD AND APPARATUS FOR GENERATING LASER PULSES

(71) Applicant: TRUMPF Laser GmbH, Schramberg (DE)

(72) Inventors: Rainer Flaig, Eschbronn (DE); Oliver Rapp, Eschbronn-Mariazell (DE); Christian Stolzenburg, Konstanz (DE); Montasser Bouzid, Dietingen (DE)

(21) Appl. No.: 17/497,990

(22) Filed: Oct. 11, 2021

Related U.S. Application Data
(63) Continuation of application No. PCT/EP2020/055996, filed on Mar. 6, 2020.

(30) Foreign Application Priority Data
Apr. 12, 2019 (DE) 10 2019 205 285.1

(51) Int. Cl. H01S 3/00; H01S 3/081; H01S 3/11

(52) U.S. Cl. CPC H01S 3/0085; H01S 3/1103; H01S 3/0813

(57) ABSTRACT

A method generates laser pulses by varying a Q-factor in a resonator. The method includes generating the laser pulses by controlling an optical modulator with a control signal for switching over between a first operating state of the optical modulator for generating a first Q-factor in the resonator and a second operating state of the optical modulator for generating a second Q-factor in the resonator. The second Q-factor is different than the first Q-factor. In order to generate a sequence of the laser pulses in which first laser pulses alternate with second laser pulses different than the first laser pulses, the optical modulator is controlled differently in each case alternately with the control signal for generating a respective first laser pulse, of the first laser pulses, and a respective second laser pulse, of the second laser pulses.

### CROSS REFERENCE TO RELATED APPLICATIONS

This application is a continuation of International Application No. PCT/EP2020/055996 (WO 2020/207676 A1), filed on Mar. 6, 2020, and claims benefit to German Patent Application No. DE 10 2019 205 285.1, filed on Apr. 12, 2019. The aforementioned applications are hereby incorporated by reference herein.

### FIELD

The present invention relates to a method and apparatus for generating laser pulses.

### BACKGROUND

Sequences of laser pulses having very short pulse durations, such as are used e.g. in material processing, can be generated in a laser resonator, for example with the aid of Q-switching or cavity dumping. In the case of pulse generation with cavity dumping, the degree of output coupling or the loss of the resonator is modulated by means of Q-switching, specifically typically between a first operating state, in which the resonator for building up a laser pulse is closed or approximately completely closed (i.e. typically degree of output coupling or loss of 0%-20%), and a second operating state, in which the laser pulse is coupled out from the resonator (degree of output coupling or loss of typically 30-100%). The loss of the resonator is a dimensionless quantity that is reciprocally proportional to the Q-factor of the resonator.

In the case of traditional Q-switching, the loss in the first operating state of the optical modulator is high, i.e. approximately 40%-100%, and the Q-factor is low, in order to build up a gain in the laser medium. In the second operating state, the Q-factor is high and the loss is low, i.e. typically approximately 0%-60%, in order to build up a laser pulse and to couple it out from the laser resonator. Unlike in the case of cavity dumping, in the case of traditional Q-switching, the laser pulse is therefore both built up and coupled out in the second operating state.

Such a modulation of the degree of output coupling or the Q-factor of the resonator can be realized, for example, with an acousto-optical modulator or a retardation device, e.g. a retardation plate, for producing a fixed phase retardation in conjunction with an optical modulator, for example, an electro-optical modulator, for producing a variable phase retardation, which is combined with a polarization-selective output coupling device in the form of a polarizer, for example. In the case of traditional Q-switching, a polarization-selective output coupling device can optionally be dispensed with, i.e. the output coupling can be effected, e.g. by means of a partly transmissive (end) mirror.

On account of the laser dynamics, laser oscillators or laser resonators may exhibit fluctuations in the pulse energy and/or in the mode profile during pulsed operation (e.g. in the case of Q-switching or in the case of cavity dumping). The oscillation-establishing mode profile, i.e. the (transverse) modes which are excited in a multimode resonator when a respective laser pulse is built up, is typically not predefined or controlled, for which reason the beam profile and the energy can fluctuate in an uncontrolled manner from laser pulse to laser pulse. As a result of the different pulse build-up times of the mode sets, temporal fluctuations or temporal jitter additionally occur(s) besides the energy fluctuation.

U.S. Pat. No. 5,365,532 describes an apparatus and a method for stabilizing the output amplitude of lasers during pulse generation by means of cavity dumping. In that case, by means of a detector, the pulse build-up or the rising intensity of the laser radiation in the resonator is monitored and the point in time at which the laser pulse is coupled out is triggered upon reaching a threshold value of the intensity. The temporal jitter that occurs on account of the triggered point in time of output coupling can be reduced by other measures.

U.S. Pat. No. 4,044,316 describes a stabilized Nd:YAG laser with cavity dumping in which relaxation oscillations are suppressed. The relaxation oscillations occur if the power exceeds its steady-state value during power build-up within the resonator, which results in an oscillation having a damping time of the order of magnitude of a few hundred milliseconds. In order to reduce the damping time, an optical crystal for frequency doubling or for second harmonic generation (SHG) is arranged in the resonator. For reducing the damping time, it is sufficient if the optical crystal generates a second harmonic power of the order of magnitude of approximately 0.1% of the power at the fundamental frequency.

### SUMMARY

In an embodiment, the present disclosure provides a method that generates laser pulses by varying a Q-factor in a resonator. The method includes generating the laser pulses by controlling an optical modulator with a control signal for switching over between a first operating state of the optical modulator for generating a first Q-factor in the resonator and a second operating state of the optical modulator for generating a second Q-factor in the resonator. The second Q-factor is different than the first Q-factor. In order to generate a sequence of the laser pulses in which first laser pulses alternate with second laser pulses different than the first laser pulses, the optical modulator is controlled differently in each case alternately with the control signal for generating a respective first laser pulse, of the first laser pulses, and a respective second laser pulse, of the second laser pulses.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic illustration of an exemplary embodiment of an apparatus for generating a sequence of laser pulses by means of cavity dumping or Q-switching in a laser resonator comprising an alternately controlled optical modulator for generating a sequence of alternating first and second laser pulses;

FIG. 2 shows an illustration analogous to FIG. 1 in which the apparatus additionally comprises a frequency doubling device in the resonator and an external modulator for suppressing the second laser pulses;

FIGS. 3a, 3b, 3c, and 3d show four illustrations of the temporal profile of a control signal for the bistable control of the optical modulator during cavity dumping;

FIG. 4 shows an illustration of the temporal profile of a control signal for the bistable control of an optical modulator during Q-switching; and

FIG. 5 shows an illustration analogous to FIG. 1 with an apparatus for generating a sequence of laser pulses during Q-switching of the laser resonator.

### DETAILED DESCRIPTION

Embodiments of the present invention provide methods and apparatuses which make it possible to reduce temporal fluctuations and energy fluctuations of the laser pulses generated by Q-switching or cavity dumping.

An embodiment of the present invention relates to a method for generating laser pulses by varying the Q-factor of a (laser) resonator. The method may include: generating the laser pulses by controlling an optical modulator for switching over between a first operating state of the optical modulator for generating a first Q-factor of the resonator and a second operating state of the optical modulator for generating a second Q-factor of the resonator, said second Q-factor being different than the first. An embodiment of the present invention also relates to an associated apparatus for generating laser pulses, comprising: a resonator, an optical modulator arranged in the resonator, and a control device configured for generating a control signal in order to switch over the optical modulator between a first operating state for generating a first Q-factor of the resonator and a second operating state for generating a second Q-factor of the resonator, the second Q-factor being different than the first.

An embodiment of the present invention provides a method, in which, in order to generate a sequence of laser pulses in which first laser pulses alternate with second laser pulses different than the first, the optical modulator is controlled differently in each case alternately with the control signal for generating a respective first laser pulse and a respective second laser pulse.

According to an aspect of the present disclosure, it is provided that, instead of reducing the fluctuations of the individual laser pulses, the laser resonator is brought into a strong bistable state by the optical modulator being controlled alternately in a targeted manner, i.e. the laser resonator oscillates between two states, which in each case has a stable mode profile or stable pulse energy. The temporal fluctuations described further above occur in particular in the range of frequencies whose period duration corresponds to the fluorescence lifetime of the laser level respectively excited (typically in the range of a few kHz in the case of Yb:YAG). In other frequency ranges, in particular at very low frequencies of <100 Hz or at very high frequencies of >1 MHz, there is generally no occurrence of uncontrolled fluctuations as a result of two different oscillation-establishing mode sets, and so generally it is not necessary for the optical modulator to be controlled alternately in a targeted manner in these frequency ranges. Typical (pulse) frequencies at which a respective (first and second) laser pulse is generated are between approximately 200 Hz and approximately 1000 kHz, preferably between approximately 1 kHz and approximately 100 kHz.

The first laser pulses and the second laser pulses typically differ by a different pulse energy, in particular by a different (maximum) pulse amplitude. As a result of the optical modulator being controlled alternately as described here, it is possible to generate a pulse sequence in which the respective first and respective second laser pulses have a temporal jitter of less than approximately 1 ns. The sequence of laser pulses typically comprises a number of, e.g., more than 1000 laser pulses, optionally more than approximately 100 000 laser pulses, depending on the application-specific operating duration, which can be 10 seconds or more, e.g., during the laser processing of a workpiece. As a result of the bistable operation of the resonator, the amount of energy contained in the respective first and respective second laser pulses can be set even in the case of a high average power. In addition, the respective first and respective second laser pulses have a high energy stability.

The sequence of laser pulses can additionally have third, fourth, . . . laser pulses that alternate with the first, second, . . . laser pulses, wherein the first, second, third, fourth, . . . laser pulses in each case differ from one another. In this case, too, the optical modulator, for generating a respective first, second, third, fourth, . . . laser pulse, is controlled differently, in each case alternately with the control signal and stable laser operation takes place, in which the states are repeated every three, four, . . . laser pulses.

In one variant, the method comprises: generating a sequence of first laser pulses by suppressing the second laser pulses, preferably by means of a further optical modulator arranged outside the laser resonator. The differentiation between first and second laser pulses is arbitrary, for which reason the above wording and the wording “generating a sequence of second laser pulses by suppressing the first laser pulses” are equivalent. That group or sequence of (first or second) laser pulses, which have a lower maximum pulse energy is typically suppressed. Suppressing a sequence or group of (first or second) laser pulses results in the frequency of the sequence of non-suppressed (second or first) laser pulses being halved. In order to generate such a sequence of laser pulses with a desired output frequency, it is therefore necessary for the optical modulator to be controlled with a control signal whose frequency corresponds to twice the desired output frequency. The suppression or masking out of the second laser pulses is preferably effected by a further (external) optical modulator, but can optionally also be effected in some other way. It goes without saying that the suppression of the second laser pulses is merely optional since it is only necessary if the suppressed laser pulses, which generally have the lower energy or power, have a disturbing effect in the respective application.

In a further variant, the optical modulator is controlled with a control signal having a constant control frequency, wherein in each case a first laser pulse and a second laser pulse, and optionally a third laser pulse, a fourth laser pulse, . . . are generated during a period duration of the control signal. The control signal generally has a signal profile that is typically switched over between two or more discrete signal levels, i.e. the signal profile typically does not have a continuous profile. Generating two laser pulses during the period duration requires switching back and forth twice between the first operating state and the second operating state. For the alternating control, the time duration during which the control signal remains at a respective signal level in the period duration, during the generation of the first and second laser pulses, can be chosen to be different. Alternatively or additionally, a respective signal level for the generation of the first laser pulse and for the generation of the second laser pulse can also be chosen to be different for the purpose of alternately controlling the optical modulator. The control frequency of the optical modulator is preferably between 200 Hz and 1000 kHz, in particular between 1 kHz and 100 kHz. For generating more than two laser pulses during a period duration, it is also possible to switch over between the first operating state and the second operating state more than twice. As has been described further above, the signal levels or the respective Q-factor of the operating states can vary in this case, too.

In one development, a residence duration of the optical modulator in the first operating state during the generation of the first laser pulse and a residence duration of the optical modulator in the first operating state during the generation of the second laser pulse (and optionally a residence duration of the optical modulator in the third operating state during the generation of a third laser pulse, a fourth laser pulse, etc.) are chosen to be different. In this variant, the gain time available for building up a respective first and second (optionally third, fourth, . . . ) laser pulse in the laser resonator is chosen to be different.

In this variant, in particular, the total residence duration of the optical modulator in the first and second operating states during the generation of the first laser pulse and during the generation of the second laser pulse can be chosen to be of the same length, i.e. the total residence duration corresponds in each case to half of the period duration of the control signal. In this case, a different residence duration of the optical modulator in the first operating state during the generation of the first/second laser pulse inevitably results in a different residence duration of the optical modulator in the second operating state during the generation of the first/second laser pulse.

In a further development, a total residence duration of the optical modulator in the first and second operating states during the generation of the first laser pulse and a total residence duration of the optical modulator in the first and second operating states during the generation of the second laser pulse are chosen to be different. The period duration available for the pulse build-up and for the output coupling of a respective laser pulse is alternated in this case. A bistable state of the laser resonator can be achieved in this way, too.

In one development, the first Q-factor during the generation of the first laser pulse and the first Q-factor during the generation of the second laser pulse are chosen to be different and/or the second Q-factor during the generation of the first laser pulse and the second Q-factor during the generation of the second laser pulse are chosen to be different. In this case, the loss of the optical modulator or the Q-factor—proportional to the reciprocal of the loss—in the first and/or second operating state during the generation of the first laser pulses and during the generation of the second laser pulses is chosen to be different. For this purpose, the control signal for the control of the optical modulator in the respective first and second operating states for generating the first and respectively second laser pulses has two different signal levels. In general, a signal level that is used for the generation of (first or second) laser pulses with a higher pulse energy is chosen such that the degree of output coupling or the loss of the laser resonator is 0%, that is to say that the laser resonator has minimal losses in the first operating state. The signal level of the control signal during the generation of the laser pulse with a lower pulse energy can be defined depending on the gain in the laser medium of the resonator. By way of example, in the case of a disk laser having a low gain, losses of the optical modulator of less than approximately 5% are sufficient to significantly reduce the pulse energy during cavity dumping, while losses of more than approximately 50% may be necessary in the case of a slab laser having a high gain.

In a further variant, a first Q-factor of the resonator for building up a laser pulse in the resonator is generated in the first operating state and a second, lower Q-factor for coupling out the laser pulse from the resonator is generated in the second operating state. In this variant, the resonator is operated with cavity dumping, i.e. a high Q-factor and thus a low loss of the resonator are produced in the first operating state, such that a laser pulse or laser power can build up, which is coupled out from the resonator in the second operating state.

In one development, the optical modulator is switched over from the first operating state into the second operating state upon reaching a predefined power threshold value of laser power built up in the resonator, wherein a first intensity threshold value is chosen during the generation of a first laser pulse and a second intensity threshold value different than the first is chosen during the generation of a second laser pulse. In this variant, the switching over from the first operating state into the second operating state is triggered by the reaching of a threshold value of the power of the laser pulse building up in the laser resonator, as is described for example in U.S. Pat. No. 5,365,532 cited in the introduction, which is incorporated by reference in its entirety in the content of this application. The power of the laser pulse building up in the laser resonator can be measured for example by means of a detector, e.g. by means of a photodiode. For the power measurement (or equivalently thereto for the measurement of the intensity of the laser radiation in the laser resonator), a fixedly predefined, small portion of the power of the laser radiation propagating in the laser resonator is typically coupled out from the laser resonator. An optical component that is present anyway in the resonator, for example a partly transmissive end mirror, can be used for the output coupling.

By virtue of a different choice of the respective power or intensity threshold value for switching over from the first operating state into the second operating state, the laser resonator can likewise be operated in a bistable state since the choice of two different power threshold values results in two different gain durations during the build-up of the first and respectively the second laser pulses. In this case, too, the optical modulator can be controlled with a control signal having a constant control frequency, i.e. the period duration of the control signal is constant, only the respective point in time of switching over from the first operating state into the second operating state during the generation both of the first laser pulse and of the second laser pulse is not precisely predefined and can fluctuate slightly in each case. It goes without saying that in principle there is also the possibility, when generating the first laser pulse, of switching over from the first operating state into the second operating state upon reaching the power threshold value and, when generating the second laser pulse, of fixedly predefining the point in time of switching over from the first operating state into the second operating state, or vice versa. In this case, the intensity threshold value can be chosen such that the associated residence duration in the first operating state when generating the first laser pulse deviates from the residence duration in the first operating state when generating the second laser pulse. Moreover, the total residence duration in the first and second operating states when generating the first laser pulse, for which the switching over from the first operating state into the second operating state is triggered by the reaching of the intensity threshold value, can differ from the total residence duration in the first and second operating states when generating the second laser pulse if the point in time of switching over from the first operating state into the second operating state is fixedly predefined when generating the second laser pulse.

In an alternative variant, a first Q-factor is generated in the first operating state for the purpose of building up a gain in a laser-active medium of the resonator and a second, higher Q-factor is generated in the second operating state for the purpose of reducing the gain in the laser-active medium and for the purpose of coupling out a laser pulse. In this variant, in the resonator traditional Q-switching is realized, wherein in the first operating state a gain is built up in the laser-active medium until a maximum gain is reached in the laser-active medium. In the second operating state the gain is reduced by a laser pulse being coupled out from the resonator.

In a further variant, a portion of laser radiation propagating at a fundamental frequency is converted into laser radiation with double the fundamental frequency by means of a frequency doubling device in the resonator. The frequency doubling device is generally an optical, typically birefringent crystal configured for second harmonic generation (SHG). The optical crystal can be for example lithium triborate (LiB₃O₅), beta barium borate (BaB₂O₄), barium sodium niobate (Ba₂Na(NbO₃)₅) or some other suitable optical crystal. Second harmonic generation has proved to be advantageous for improving the energy stability.

A further aspect of the present disclosure relates to an apparatus of the type mentioned above, wherein the control device is embodied or configured/programmed, for the purpose of generating a sequence of laser pulses in which first laser pulses alternate with second laser pulses different than the first, to control the optical modulator differently in each case alternately for generating a respective first laser pulse and a respective second laser pulse by means of the control signal. The control device can be for example a control computer or an electronic control circuit (IC, programmable gate array etc.) which generates the desired control signal. The control signal, to put it more precisely the signal profile thereof, is configured differently for the generation of the first laser pulses and for the generation of the second laser pulses, as has been described further above in association with the method. The control device can be configured, in particular, to generate a control signal in the form of a control voltage that is applied to an electrode of an electro-optical modulator, for example in the form of a Pockels cell.

In one embodiment, the apparatus additionally comprises a further optical modulator for suppressing the second laser pulses, the further optical modulator being arranged outside the laser resonator. The optical modulator can be configured for example to deflect the second laser pulses from the beam path of the first laser pulses, as is the case for an acousto-optical modulator. It goes without saying that, for this purpose, the first laser pulses or the beam path of the first laser pulses can also be deflected by the optical modulator, while the second laser pulses pass through this without deflection. Optionally, the second laser pulses can also be suppressed by a rapidly switchable optical filter or by means of a further electro-optical modulator in combination with a polarizer for splitting the first and second laser pulses between different beam paths. The further optical modulator is only required if the second laser pulses have a disturbing effect in the respective application for which the laser pulses are required. If this is the case, the frequency of the sequence of laser pulses generated by the apparatus is halved. In this case, it is necessary to control the optical modulator with a control signal whose control frequency is twice the desired frequency of the sequence of laser pulses.

Preferably, the control device is embodied or configured/programmed to control the optical modulator with a control signal having a constant control frequency that serves for generating a first laser pulse and a second laser pulse during a period duration of the control signal. It is expedient if the control frequency of the control signal is between approximately 1 kHz and approximately 1000 kHz, preferably between approximately 1 kHz and approximately 100 kHz.

In one embodiment, the control device is configured to generate a first Q-factor of the resonator for building up a laser pulse in the resonator in the first operating state and to generate a second, lower Q-factor for coupling out the laser pulse from the resonator in the second operating state. As has been described further above in association with the method, the resonator is operated with cavity dumping in this case.

In a further embodiment, the apparatus comprises a detector for detecting a power of the laser pulse building up in the laser resonator in the first operating state of the optical modulator. As has been described further above, the detector can be a photodiode or the like, for example, which detects the power of laser radiation coupled out from the laser resonator during the first operating state. The measured power can serve to suitably choose the point in time of output coupling, i.e. the point in time of switching over from the first operating state into the second operating state (see below).

In a further embodiment, the control device is configured to switch over the optical modulator between the first operating state and the second operating state upon reaching a predefined power threshold value of laser power built up in the laser resonator, and the control device is configured to predefine a first power threshold value for the purpose of generating a first laser pulse and a second power threshold value different than the first for the purpose of generating a second laser pulse. In this embodiment, the value of the power which is currently present in the laser resonator, which value can be measured for example in the manner described further above in association with the method, is compared with a power threshold value that is different during the generation of the first and second laser pulses. A strong bistable state of laser operation can be produced in this way, too.

In a further embodiment, the control device is configured to generate a first Q-factor for the purpose of building up a gain in a laser-active medium of the resonator in the first operating state and to generate a second, higher Q-factor for the purpose of reducing the gain in the laser-active medium and for the purpose of coupling out a laser pulse in the second operating state. As has been described further above in association with the method, the resonator is operated with traditional Q-switching in this case.

In a further embodiment, a frequency doubling device serving for converting a portion of laser radiation propagating with a fundamental frequency in the resonator into laser radiation at double the fundamental frequency is arranged in the resonator. The frequency doubling device can be, in particular, a nonlinear, for example birefringent, crystal. As is generally customary in the case of frequency conversion, a phase adaptation is required in this case, too, for the frequency conversion, the phase adaptation possibly requiring suitable temperature regulation of the optical crystal.

In a further embodiment, the resonator additionally comprises: a laser-active medium, an in particular polarization-selective output coupling device, for example a polarizer, for coupling out the laser pulses from the resonator, and preferably a phase retardation device for producing a fixed phase retardation. The laser-active medium is typically a solid-state medium, for example in the form of a laser crystal, e.g. in the form of Yb:YAG, Nd:YAG, Nd:YVO₄, . . . . The laser-active (solid-state) medium can be configured in the form of a laser disk, a laser rod, a laser slab, etc. For the excitation of the laser-active medium, the latter is typically pumped with the aid of pump radiation, for which purpose the apparatus can comprise a pump light source, for example a pump laser source.

The cavity dumping and the Q-switching can also be effected without a phase retardation device, for example if an acousto-optical modulator is used as an optical modulator. However, a retardation device consisting of an optical modulator and optionally an additional retardation plate is generally used for the cavity dumping. In this case, the modulator produces a temporally variable phase retardation, while the retardation plate produces a fixedly predefined phase retardation. The retardation plate can be for example a λ/4 retardation plate (or a λ/2 plate in the case of ring lasers), but other retardations are also expedient. The retardation device generally produces its maximum phase retardation in the second operating state, which has the effect that the laser radiation is maximally retarded upon double passage through the retardation device, such that a laser pulse can be coupled out from the laser resonator at the polarization-selective output coupling device. In the case of a linear resonator with a λ/4 retardation plate, the polarization of the laser radiation can be rotated by 90° upon double passage through the retardation, which corresponds to the maximum output coupling. The polarization-selective output coupling device can be a thin-film polarizer, for example, which transmits laser radiation having a first polarization direction and reflects laser radiation having a second polarization direction perpendicular to the first. Other types of polarizers can also be used as a polarization-selective output coupling device in the laser resonator, e.g. polarizers comprising birefringent media which enable a beam offset of the polarization components (s- and respectively p-polarization) in the birefringent medium and thus a separation of the polarization components, etc. The retardation device for producing the fixed phase retardation prevents the resonator from being closed in the case of a fault, i.e. in the case of a failure of the optical modulator, such that the laser pulse cannot be coupled out and is amplified further until it damages components in the resonator. The fixed phase retardation of the retardation device is chosen here such that the laser pulse is automatically coupled out in the case of a fault, i.e. in the case of the failure of the optical switch.

A resonator with a polarization-selective output coupling device and optionally a retardation device with fixed phase retardation can also be operated with traditional Q-switching. In this case, the laser pulses can be coupled out from the resonator without polarization selection, for example by the laser pulses being coupled out from the resonator at an output coupling device in the form of a partly transmissive output coupling mirror, e.g. a partly transmissive end mirror. In this case, the losses in the resonator are produced by the optical modulator and a polarization-selective element.

Further advantages of embodiments of the present invention are evident from the description and the drawing. Likewise, the features mentioned above and those presented further below can be used in each case by themselves or as a plurality in any desired combinations. The embodiments shown and described should not be understood as an exhaustive list, but rather are of exemplary character for outlining the invention.

In the following description of the drawings, identical reference signs are used for identical or functionally identical components.

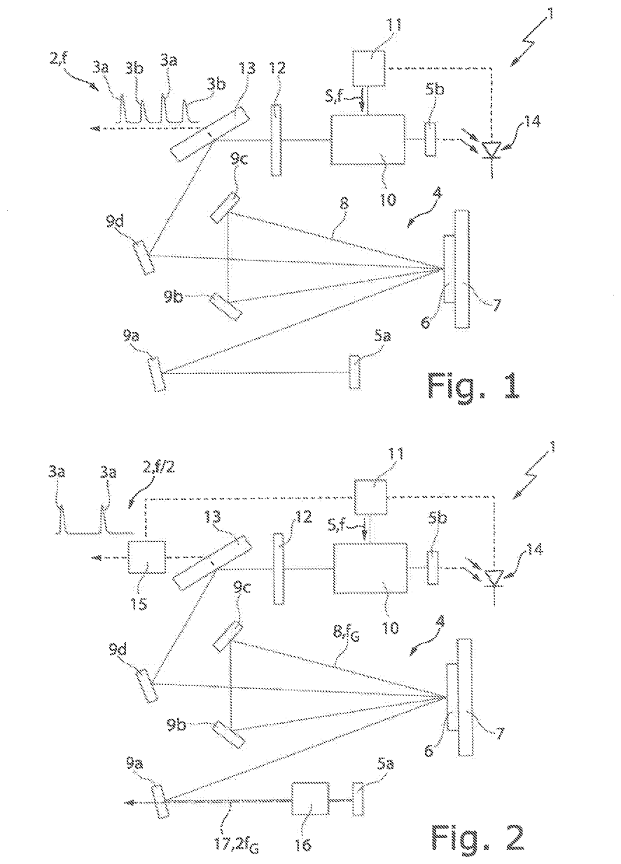

FIG. 1 shows an exemplary construction of an apparatus 1 for generating a sequence 2 of laser pulses 3a, 3b, the apparatus comprising a laser resonator 4. The laser resonator 4 comprises two end mirrors 5a, 5b and a disk-shaped laser-active medium 6, in the present example a Yb:YAG crystal, which is applied to a heat sink 7. The laser-active medium 6 is reflectively coated on its side facing the heat sink 7 and is optically excited by the pump radiation of a pump laser, as a result of which laser radiation 8 at a laser wavelength λ of 1030 nm is generated in the laser resonator 4.

The laser resonator 4 comprises a plurality of folding mirrors 9a-d in order to produce a multiple passage of the laser radiation 8 through the laser-active solid-state medium 6. The laser radiation 8 generated in the laser resonator 4 or in the laser-active solid-state medium 6 is linearly polarized, e.g. s-polarized.

The laser resonator 4 furthermore comprises an optical modulator 10 in the form of an electro-optical modulator, to put it more precisely a Pockels cell, and a control device 11 for controlling the electro-optical modulator 10 with a control signal S. Also arranged in the laser resonator 4 are a retardation device 12, for example in the form of a λ/4 retardation plate for producing a constant phase retardation of λ/4, and a polarization-selective output coupling device 13 in the form of a thin-film polarizer, which acts as a partly transmissive mirror and at which the laser pulses 3a, 3b generated in the laser resonator 4 are coupled out, as is described in detail below.

The optical modulator 10 is operated in two operating states B1, B2, in principle, for the cavity dumping. The first operating state B1 serves to build up a laser pulse 3a, 3b in the resonator 4, while in the second operating state B2, a respective laser pulse 3a, 3b is coupled out from the resonator 4.

In the first operating state B1, a control signal S (in the form of a voltage signal) can be applied to the electro-optical modulator 10 by means of the control device 11, the signal generating a (positive) quarter-wave voltage, i.e. a voltage that brings about a phase retardation of the laser radiation 8 of +λ/4. The retardation plate 12 produces an oppositely directed phase retardation of −λ/4, such that the sum of the phase retardations of the retardation plate 12 and of the electro-optical modulator 10 in the first operating state B1 is zero. Therefore, the polarization state of the s-polarized laser radiation 8 generated in the laser resonator 4 is not altered, the laser radiation impinging in s-polarized fashion on the thin-film polarizer 13 and being deflected at the latter, i.e. the laser radiation 8 is not coupled out at the thin-film polarizer 13. The definition of the sign of the phase retardation is based on a convention in which a positive/negative voltage applied to the electro-optical modulator 10 brings about a phase retardation having a positive/negative sign.

In the second operating state B2, a phase retardation of zero is produced at the electro-optical modulator 10, i.e. no voltage difference or a control signal S having a voltage of 0V is present at the modulator. In this case, the double passage of the laser radiation 8 through the retardation plate 12 results in a phase retardation of 2×(−λ/4)=−λ/2. This phase retardation has the effect that the polarization direction (E-vector) of the linearly polarized laser radiation 8 is rotated by 90°, such that the latter impinges in p-polarized fashion on the output coupling device in the form of the thin-film polarizer 13 and is coupled out from the laser resonator 4 at the polarizer. Given a suitably designed and controlled electro-optical modulator 10, the retardation plate 12 can also have an (arbitrary) fixed phase retardation different than ±λ/4.

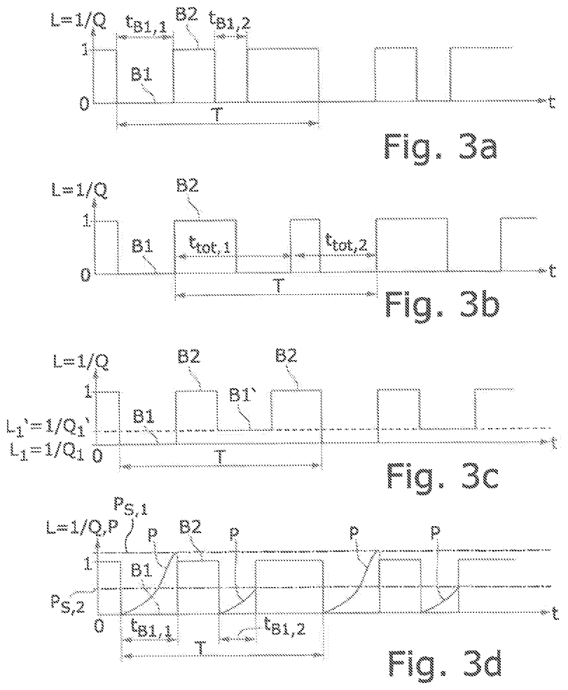

The laser resonator 4 illustrated in FIG. 1 is operated in a bistable state in which a sequence 2 of alternating first and second laser pulses 3a, 3b is generated, the laser pulses differing from one another in at least one property. As is evident in FIG. 1, in this case the first laser pulses 3a have a greater maximum pulse power or energy than the second laser pulses 3b The first laser pulses 3a can alternatively have a lower energy or a lower maximum pulse power than the second laser pulses 3b. In order to generate the alternating first and second laser pulses 3a, 3b with different properties, the electro-optical modulator 10 is controlled alternately with the control signal S, wherein there are a number of possibilities for alternately controlling the electro-optical modulator 10, from among which for example four possibilities are illustrated by way of example in FIGS. 3a-d. In order to generate a sequence with third, fourth, . . . laser pulses having in each case different properties than the other (first, second, . . . ) laser pulses, the electro-optical modulator 10 can be controlled accordingly in order to realize stable laser operation in three, four, . . . states.

In all four examples shown in FIGS. 3a-d, the control signal S has a constant control frequency f, which can be for example of the order of magnitude of a few kHz, e.g. between 200 Hz and 1000 kHz, preferably between 1 kHz and 100 kHz. During a period duration T of the control signal S, the optical modulator 10 is controlled in each case such that a first laser pulse 3a and a second laser pulse 3b are generated. Generating a respective first or second laser pulse 3a, 3b necessitates switching back and forth between the first operating state B1 and the second operating state B2 once in each case. In FIGS. 3a-d there is plotted in each case the signal level of the control signal S or the Q-factor Q, to put it more precisely 1/Q (proportional to the loss L), between a maximum loss L (corresponding to a minimum Q-factor Q) designated by a one and a minimum loss L (corresponding to a maximum Q-factor Q) designated by zero. In the case of the minimum Q-factor Q (and maximum loss L), in the example shown, the optical modulator 10 produces the phase retardation of zero described further above, while, in the case of the maximum Q-factor Q (and minimum loss L), the optical modulator 10 produces a phase retardation of +λ/4 (see above).

In the example shown in FIG. 3a, the alternate control is effected with a control signal S in which the time duration for the generation of a respective first laser pulse 3a and of a respective second laser pulse 3b is of the same magnitude and corresponds to half of the period duration T/2 of the control signal S. In the example shown in FIG. 3a, however, the residence duration t_{B1,1} in the first operating state B1 during the generation of the first laser pulse 3a differs from the residence duration t_{B1,2} in the first operating state B1 during the generation of the second laser pulse 3b. The residence duration t_{B1,1} in the first operating state B1 during the generation of the first laser pulse 3a is greater than the residence duration t_{B1,2} in the first operating state B1 during the generation of the second laser pulse 3b. In this way, a longer period of time is available for the gain or for the pulse build-up of a respective first laser pulse 3a, which leads to the higher maximum power of the first laser pulse 3a in comparison with the second laser pulse 3b, as shown in FIG. 1.

In the example shown in FIG. 3b, the alternate control is likewise realized by the switching over between the first and second operating states B1, B2 during the generation of the two laser pulses 3a, 3b being effected at different points in time. In the example shown in FIG. 3b, however, the respective residence duration t_{B1,1} and t_{B1,2} in the first operating state B1 for the first laser pulse 3a and for the second laser pulse 3b is of the same length. In FIG. 3b, however, the total residence duration t_{tot,i} of the optical modulator 10 in the first operating state B1 and in the second operating state B2 during the generation of the first laser pulse 3a differs from the total residence duration t_{tot,2} of the optical modulator 10 in the first operating state B1 and in the second operating state B2 during the generation of the second laser pulse 3b. The sum of the two residence durations t_{tot,1} and respectively t_{tot,2} corresponds to the constant period duration T of the control signal S. On account of the greater total residence duration t_{tot,1} of the optical modulator 10 during the generation of the first laser pulse 3a, the latter has a greater maximum pulse power than the second laser pulse 3b. What is essential here is that, on account of the longer residence duration of the optical modulator 10 in the second operating state B2 during the generation of the first laser pulse 3a, more energy or gain is introduced into the laser-active medium 6 than during the generation of the second laser pulse 3b. Accordingly, during the subsequent residence duration in the first operating state B1, it is possible to extract more energy for the first laser pulse than for the second laser pulse.

The possibilities for alternate control illustrated in FIG. 3a and in FIG. 3b can also be combined, i.e. the residence duration t_{B1,1} in the first operating state B1 and the total residence duration t_{tot,1} in the first and second operating states B1, B2 during the generation of the first laser pulse 3a can differ from the residence duration t_{B1,2} in the first operating state B1 and respectively from the total residence duration t_{tot,2} in the first and second operating states B1, B2 during the generation of the second laser pulse 3b.

In the example shown in FIG. 3c, the different control for generating the two laser pulses 3a, 3b is not effected by means of different residence durations in the two operating states B1, B2, but rather by means of a Q-factor Q₁ of the optical modulator 10 in the first operating state B1 during the generation of the first laser pulse 3a, which differs from a Q-factor Q₁′ of the optical modulator 10 in the first operating state B1′ during the generation of the second laser pulse 3b. The respective Q-factor Q₁, Q₁′ constitutes a dimensionless value and is reciprocally proportional to the loss L₁, L₁′. For the first operating state B1 during the generation of the first laser pulse 3a, as in the case of the two examples in FIGS. 3a, b, it holds true that the loss L₁ of the laser resonator 4 is practically equal to zero and the Q-factor Q₁ is at a maximum. For the first operating state B1′ in which the optical modulator 10 is operated during the generation of the second laser pulse 3b, the following holds true, by contrast: L₁′=0.2, wherein other values for the loss L₁′ are possible depending on the type of laser-active medium 6, which values can be between 0.01 and 0.5, for example. During the generation of the second laser pulse 3b in the first operating state B1′, the optical modulator 10 is controlled with a control signal S having a signal level which brings about a phase retardation of the optical modulator 10 that is different than zero. This has the effect that the polarization direction (E-vector) of the linearly polarized laser radiation 8 is rotated and has a portion that is coupled out from the laser resonator 4 during the first operating state B1′. In this way, the second laser pulse 3b can extract and build up less energy, with the result that its maximum pulse power is lower than in the case of the first laser pulse 3a.

Finally, FIG. 3d shows a possibility for alternately controlling the optical modulator 10, wherein the optical modulator 10 is switched over from the first operating state B1 into the second operating state B2 as soon as the power P of the laser radiation 8 built up in the laser resonator 4 exceeds a predefined power threshold value P_{S,1}, P_{S,2}, which is chosen to have different magnitudes for the generation of the two laser pulses 3a, 3b. In the example shown, the first power threshold value P_{S,1} for the first laser pulse 3a is chosen to be greater than the second power threshold value P_{S,2} for the second laser pulse 3b. Accordingly, during the generation of the first laser pulse 3a, the optical modulator 10 is switched over from the first operating state B1 into the second operating state B2 at a later point in time, i.e. the residence duration t_{B1,1} in the first operating state B1 during the generation for the first laser pulse 3a is greater than the residence duration t_{B1,2} in the first operating state B1 during the generation of the second laser pulse 3b.

The exact residence duration t_{B1,1}, t_{B1,2} in the first operating state B1 is determined by the reaching of the respective power threshold value P_{S,1}, P_{S,2}, which fluctuates slightly in each case during the generation of the sequence 2 of laser pulses 3a, 3b in the case of successive first laser pulses 3a and respectively second laser pulses 3b. The control signal S nevertheless has a constant control frequency fin this case, too, since the switching over from the second operating state B2 into the first operating state B1 is effected in each case at fixedly predefined points in time within a respective period duration T. Accordingly, the control signal S shown in FIG. 3d differs from the control signal S shown in FIG. 3a merely in that the point in time of switching over from the first operating state B1 into the second operating state B2 is not fixedly predefined, but rather is triggered by the reaching of the respective power threshold value P_{S,1}, P_{S,2}.

In order to determine the (instantaneous) power P of the laser radiation 8 in the laser resonator 4 in the first operating state B1, the apparatus 1 shown in FIG. 1 comprises a detector 14 configured in the form of a photodiode. The detector 14 is arranged outside the laser resonator 4. In order that a small portion of the laser radiation 8 propagating in the laser resonator 4 is coupled out for the detection, the second end mirror 5b of the laser resonator 4 is configured as partly transmissive, i.e. it has a transmission of approximately 0.01% or less for the laser radiation 8 propagating in the laser resonator 4. The detector 14 can optionally be dispensed with if the optical modulator 10 is controlled alternately in the manner described in association with FIGS. 3a-c.

FIG. 2 shows an apparatus 1 for generating a sequence 2 of laser pulses, which apparatus differs from the apparatus 1 shown in FIG. 1 substantially in that it comprises a further optical modulator 15 in the form of an acousto-optical modulator, for example, which is arranged outside the laser resonator 4. The further optical modulator 15 serves to couple out, or to suppress, the second laser pulses 3b from the sequence 2 of first and second laser pulses 3a, 3b coupled out from the laser resonator 4. The acousto-optical modulator 15 diverts the second laser pulses 3b to an absorber. For the diversion, a phase diffraction grating is produced by the acousto-optical modulator 15 in an optical crystal with the aid of an ultrasonic generator with a predefined switching frequency f/2 corresponding to half the control frequency f of the control signal S.

Alternatively, the external optical modulator 15 can be a further electro-optical modulator, e.g. in the form of a Pockels cell, for producing a phase shift or phase retardation. In both cases, the external optical modulator 15 can be controlled with half the control frequency f of the control signal f/2 with the aid of the control device 11 in order to eliminate the second laser pulses 3b from the sequence 2 of laser pulses 3a, 3b, such that only the first laser pulses 3a leave the apparatus 1. A dedicated control device, e.g. in the form of an electronic control circuit, can optionally be provided for the further optical modulator 15. In this case, it is necessary to suitably synchronize the control of the optical modulator 10 and of the further optical modulator 15. For this purpose, by way of example, a common frequency generator can be provided in the apparatus 1.

The laser radiation 8 generated in the laser resonator 4 has a fundamental frequency f_{G} that is proportional to the reciprocal of the laser wavelength λ. For the additional suppression of temporal jitter and in particular of energy fluctuations during the generation of the sequence of laser pulses 3a, 3b, a frequency doubling device 16 in the form of a frequency doubling crystal (SHG crystal) is arranged in the laser resonator 4 in FIG. 2. In the SHG crystal 16, a small portion (generally less than 10% or less than 1%) of the laser radiation 8 generated in the laser resonator 4 is converted into laser radiation 17 having double the fundamental frequency 2 f_{G}. At one of the deflection mirrors 9a which is configured as a wavelength-selective optical element, the converted laser radiation 17 is transmitted and coupled out from the laser resonator 4.

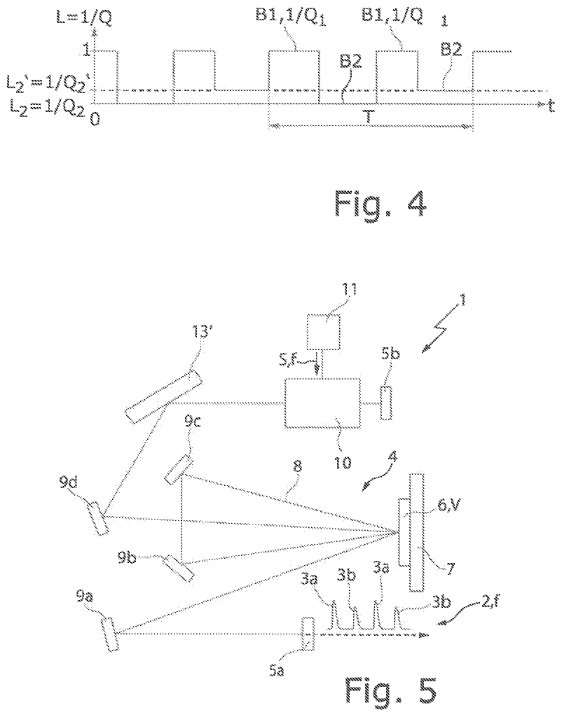

FIG. 4 shows the temporal profile of the control signal S when the laser resonator 4 is operated with conventional Q-switching rather than with cavity dumping as illustrated in FIGS. 3a-d. In this case, in the first operating state B1, a gain V is built up in the laser-active medium 6 of the resonator 4 by the resonator 4 being operated with a high loss L₁ of almost L₁=1.0 or with a Q-factor Q₁ of close to zero. As soon as the gain V in the laser-active medium 6 has assumed its maximum value (at a fixedly predefined point in time), the optical modulator 10 is switched over from the first operating state B1 into the second operating state B2. In the second operating state B2, the optical modulator 10 generates a (second) Q-factor Q₂ that is greater than the first Q-factor Q₁ in the first operating state B1 (the loss L₂, L₂′ is close to zero), in order to reduce the gain V in the laser-active medium 6 and in order to couple out the laser pulses 3a, 3b from the laser resonator 4.

In the example shown in FIG. 4, the second Q-factor Q₂ during the generation of the first laser pulse 3a and the second Q-factor Q₂′ during the generation of the second laser pulse 3b in the second operating state B2 are chosen to be different, wherein the second Q-factor Q₂ during the generation of the first laser pulse 3a is greater than the second Q-factor Q₂′ during the generation of the second laser pulse 3b (and accordingly the loss L₂ is less than the loss L₂′). Accordingly, a respective first laser pulse 3a has a greater pulse energy than a respective second laser pulse 3b. As an alternative or in addition to the control of the optical modulator 10 as shown in FIG. 4, first and second laser pulses 3a, 3b that differ from one another in at least one property can also be generated analogously to the manner described further above in association with FIGS. 3a, b for the cavity dumping.

FIG. 5 shows an example of an apparatus 1 for generating laser pulses 3a, 3b for which the laser resonator 4 is likewise operated with conventional Q-switching. The apparatus 1 shown in FIG. 5 differs substantively from the apparatus shown in FIG. 1 merely in that the first end mirror 5a of the resonator 4 is configured as a partly transmissive mirror (e.g. having a transmission of 10%) and serves as an output coupling device, while the thin-film polarizer 13′ does not act as an output coupling device, i.e. is not configured as partly transmissive. The retardation plate 12 can be dispensed with in this case. The losses in the resonator 4 are produced by the acousto-optical modulator 10 in this case. In the case of the apparatus 1 shown in FIG. 5, too, the control of the acousto-optical modulator 10 with the control signal S can be effected in the manner described in FIG. 4. Instead of an acousto-optical modulator, an electro-optical modulator can also be used in the apparatus in FIG. 5.

With the aid of the alternate control of the optical modulator 10, the laser resonator 4 can be operated in a robust bistable state. In this way, a sequence 2 of laser pulses 3a, 3b for which both very low temporal jitter and a high energy stability of the respective laser pulses 3a, 3b can be realized can be generated by means of the apparatus 1.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for generating laser pulses by varying a Q-factor in a resonator, the method comprising:
generating the laser pulses by controlling an optical modulator with a control signal for switching over between a first operating state of the optical modulator for generating a first Q-factor in the resonator and a second operating state of the optical modulator for generating a second Q-factor in the resonator, the second Q-factor being different than the first Q-factor,
wherein,
in order to generate a sequence of the laser pulses in which first laser pulses alternate with second laser pulses different than the first laser pulses, the optical modulator is controlled differently in each case alternately with the control signal for generating a respective first laser pulse, of the first laser pulses, and a respective second laser pulse, of the second laser pulses.

2. The method as claimed in claim 1, the method further comprising: generating a sequence of first laser pulses by suppressing the second laser pulses.

3. The method as claimed in claim 1, wherein the optical modulator is controlled with the control signal having a constant control frequency, wherein in each case a first laser pulse, of the first laser pulses, and a second laser pulse, of the second laser pulses, are generated during a period duration of the control signal.

4. The method as claimed in claim 1, wherein a first residence duration of the optical modulator in the first operating state during the generation of the respective first laser pulse and a second residence duration of the optical modulator in the first operating state during the generation of the respective second laser pulse are chosen to be different.

5. The method as claimed in claim 1, wherein a first total residence duration of the optical modulator in the first operating state and the second operating state during the generation of the respective first laser pulse and a second total residence duration of the optical modulator in the first operating state and the second operating state during the generation of the respective second laser pulse are chosen to be different.

6. The method as claimed in claim 1, wherein the first Q-factor during the generation of the respective first laser pulse and the first Q-factor during the generation of the respective second laser pulse are chosen to be different, or wherein the second Q-factor during the generation of the respective first laser pulse and the second Q-factor during the generation of the respective second laser pulse are chosen to be different.

7. The method as claimed in claim 1, wherein the first Q-factor of the resonator for building up a respective one of the laser pulses in the resonator is generated in the first operating state, and wherein the second Q-factor for coupling out the respective one of the laser pulses from the resonator is lower than the first Q-factor and is generated in the second operating state.

8. The method as claimed in claim 7, wherein the optical modulator is switched over from the first operating state into the second operating state upon reaching a predefined power threshold value of laser power built up in the resonator, wherein a first intensity threshold value is chosen during the generation of the respective first laser pulse and a second intensity threshold value different than the first intensity threshold value is chosen during the generation of the respective second laser pulse.

9. The method as claimed in claim 1, wherein the first Q-factor is generated in the first operating state to build up a gain in a laser-active medium of the resonator, and wherein the secondQ-factor is higher than the first Q-Factor and is generated in the second operating state to reduce the gain in the laser-active medium and to couple out one of the laser pulses.

10. The method as claimed in claim 1, wherein a portion of laser radiation propagating with a fundamental frequency in the resonator is converted into laser radiation with double the fundamental frequency by a frequency doubler.

11. An apparatus for generating laser pulses, the apparatus comprising:
a resonator;
an optical modulator arranged in the resonator;
a control device configured for generating a control signal configured to switch over the optical modulator between a first operating state for generating a first Q-factor of the resonator and a second operating state for generating a second Q-factor of the resonator, the second Q-factor being different than the first Q-factor,
wherein:
the control device is further configured, for generating a sequence of the laser pulses in which first laser pulses alternate with second laser pulses different than the first laser pulses, to control the optical modulator differently in each case alternately for generating a respective first laser pulse, of the first laser pulses, and a respective second laser pulse, of the laser pulses, by the control signal.

12. The apparatus as claimed in claim 11, further comprising: a further optical modulator configured to suppress the second laser pulses, the further optical modulator being arranged outside the resonator.

13. The apparatus as claimed in claim 11, wherein the control device is configured to control the optical modulator with the control signal having a constant control frequency for generating the respective first laser pulse and the respective second laser pulse during a period duration of the control signal.

14. The apparatus as claimed in claim 11, wherein the control device is configured to generate the first Q-factor of the resonator for building up one of the laser pulses in the resonator in the first operating state and to generate the second Q-factor for coupling out one of the laser pulses from the resonator in the second operating state, the second Q-factor being lower than the first Q-factor.

15. The apparatus as claimed in claim 11, further comprising: a detector configured to detect laser power built up in the resonator in the first operating state of the optical modulator.

16. The apparatus as claimed in claim 15, wherein the control device is configured to switch over the optical modulator between the first operating state and the second operating state upon reaching a predefined power threshold value of the laser power built up in the resonator, and wherein the control device is configured to predefine a first power threshold value for the purpose of generating the respective first laser pulse and a second power threshold value different than the first power threshold value for the purpose of generating the respective second laser pulse.

17. The apparatus as claimed in claim 11, wherein the control device is configured to generate the first Q-factor for the purpose of building up a gain in a laser-active medium of the resonator in the first operating state and to generate the second Q-factor for the purpose of reducing the gain in the laser-active medium and for the purpose of coupling out one of the laser pulses in the second operating state, the second Q-factor being higher than the first Q-factor.

18. The apparatus as claimed in claim 11, further comprising: a frequency doubler arranged in the resonator and configured to convert a portion of laser radiation propagating with a fundamental frequency in the resonator into laser radiation at double the fundamental frequency.

19. The apparatus as claimed in claim 11, wherein the resonator further comprises:
a laser-active medium;
a polarization-selective output coupler configured to couple out certain ones of the laser pulses from the resonator, and
a phase retardation device.

20. The method as claimed in claim 2, the method further comprising: generating the sequence of first laser pulses by suppressing the second laser pulses by means a further optical modulator arranged outside the resonator.
